(19) United States
(12) Patent Application Publication
(10) Pub. No.: US 2011/0092353 A1
(43) Pub. Date: Apr. 21, 2011

(54) DURABLE GLASS-CERAMIC HOUSINGS/ENCLOSURES FOR ELECTRONIC DEVICE

(75) Inventors: Jaymin Amin, Corning, NY (US); Lorrie Foley Beall, Painted Post, NY (US); George Halsey Beall, Big Flats, NY (US); Matthew John Dejneka, Corning, NY (US); Linda Ruth Pinckney, Corning, NY (US); Katherine Rose Rossington, Corning, NY (US)

(73) Assignee: CORNING INCORPORATED, Corning, NY (US)

(21) Appl. No.: 12/991,567

(22) PCT Filed: Jul. 2, 2009
(86) PCT No.: PCT/US2009/003943

§ 371 Date: Nov. 8, 2010

Related U.S. Application Data
(60) Provisional application No. 61/077,976, filed on Jul. 3, 2008.
(60) Provisional application No. 61/118,049, filed on Nov. 26, 2008.

(51) Int. Cl. C03C 10/14; C03C 10/00; C03C 10/04; C03C 10/16

(52) U.S. Cl. 501/3; 501/2; 501/5; 501/4

(57) ABSTRACT

The invention relates glass ceramic articles suitable for use as electronic device housing or enclosures which comprise a glass-ceramic material. Particularly, a glass-ceramic article housing/enclosure comprising a glass-ceramic material exhibiting both radio and microwave frequency transparency, as defined by a loss tangent of less than 0.5 and at a frequency range of between 15 MHz to 3.0 GHz, a fracture toughness of greater than 1.5 MPa·m^{1/2}, an equibiaxial flexural strength (ROR strength) of greater than 100 MPa, a Knoop hardness of at least 400 kg/mm², a thermal conductivity of less than 4 W/m° C. and a porosity of less than 0.1%.

### CROSS-REFERENCE TO RELATED APPLICATIONS

This application claims the benefit of priority under 35 U.S.C. §119(e) of U.S. Provisional Application Ser. No. 61/118,049 filed on Nov. 26, 2008, which claims the benefit of priority under 35 U.S.C. §119(e) of U.S. Provisional Application Ser. No. 61/077,976 filed on Jul. 3, 2008.

### TECHNICAL FIELD

The invention is directed to glass-ceramics that can be used as durable housings or enclosures for electronic devices. In particular, the invention is directed to glass-ceramics that exhibit fracture toughness and hardness higher than those exhibited by glass, low thermal conductivity, transparency to radio and microwave frequencies and which are particularly suitable for use as durable housings or enclosures for electronic devices.

### BACKGROUND

In the past decade portable electronic devices such as laptops, PDAs, media players, cellular phones, etc. (frequently referred to as “portable computing devices”), have become small, light and powerful. One factor contributing to the development and availability of these small devices is the manufacturer's ability to reduce of the device's electronic components to ever smaller and smaller sizes while simultaneously increasing both the power and or operating speed of such components. However, the trend to devices that are smaller, lighter and more powerful presents a continuing challenge regarding design of some components of the portable computing devices.

One particular challenge associated with the design of the portable computing devices is the enclosure used to house the various internal components of the device. This design challenge generally arises from two conflicting design goals—the desirability of making the enclosure lighter and thinner, and the desirability of making the enclosure stronger, more rigid and fracture resistant. The lighter enclosures, which typically use thin plastic structures and few fasteners, tend to be more flexible and have a greater tendency to buckle and bow as opposed to stronger and more rigid enclosures which typically use thicker plastic structures and more fasteners which are thicker and have more weight. Unfortunately, the increased weight of the stronger, more rigid structures may lead to user dissatisfaction, and bowing/buckling of the lighter structures may damage the internal parts of the portable computing devices.

In view of the foregoing problems with existing enclosures or housings, there is a need for improved enclosures or housings for portable computing devices. In particular, there is a need for enclosures that are smaller, lighter, stronger, more fracture resistant and aesthetically more pleasing than current enclosure designs.

### SUMMARY

One embodiment disclosed herein relates to portable electronic devices capable of wireless communications. The portable electronic devices include an enclosure or housing (hereinafter simply referred to as an “enclosure”) that surrounds and protects the internal operational components of the electronic device. The enclosure is comprised of a glass-ceramic material that permits wireless communications therethrough. The wireless communications may for example correspond to RF communications, thereby allowing the glass-ceramic material to be transparent to radio waves.

The invention further relates to an article suitable for housing or enclosing the components of a portable electronic device, the article comprising a glass-ceramic material exhibiting both radio and microwave frequency transparency, as defined by a loss tangent of less than 0.5 and at a frequency range of between 15 MHz to 3.0 GHz, a fracture toughness of greater than 1.0 MPa·m^{1/2}, an equibiaxial flexural strength (ROR Strength) of greater than 100 MPa, a Knoop hardness of at least 400 kg/mm², a thermal conductivity of less than 4 W/m° C. and a porosity of less than 0.1%.

The glass-ceramic article enclosure can be used in a variety of consumer electronic articles, for example, cell phones and other electronic devices capable of wireless communication, music players, notebook computers, game controllers, computer “mice”, electronic book readers and other devices. The glass-ceramic article enclosures have been found to have a “pleasant feel” when held in the hand.

### DETAILED DESCRIPTION

As is described herein below, the needs of the industry for more cost effective, smaller, lighter, stronger, more fracture resistant and aesthetically more pleasing electronic device enclosures are achieved by the use of a durable glass-ceramic articles as that outer shell or enclosure. These glass-ceramic enclosures are particularly suitable for use in the aforementioned electronic devices such as cell phones, music players, notebook computers, game controllers, computer “mice”, electronic book readers and other devices. These glass-ceramic materials possess certain advantages such as being lightweight and/or resistance to impact damage (e.g., denting), over the present materials such as plastic and metal. Furthermore, the glass-ceramic materials described herein are not only durable, but can also be made in a wide range of colors, a feature that is highly desirable in meeting the desires and demands of the end-user consumer. Lastly, unlike many of the materials presently used for enclosures, in particular metallic enclosures, the use of glass-ceramic materials does not interfere with or block wireless communications. As used herein the terms “enclosure” and “housing” are used interchangeably.

The glass-ceramic material which is suitable for use in housing or enclosing the components of a portable electronic device may be formed from a variety of glass-ceramic materials. In particular, numerous glass-ceramic compositional families can be employed for this application. While glass-ceramics based on borates, phosphates, and chalcogenides exist and can be used in practicing the invention, the preferred materials for this application comprise silicate-based compositions due to silicate materials generally possessing superior chemical durability and mechanical properties.

The material selected generally depends on many factors including but not limited to radio and microwave frequency transparency, fracture toughness, strength, hardness, thermal conductivity and porosity. Formability (and reformability), machinability, finishing, design flexibility, and manufacturing costs associated with the glass-ceramic material are also factors which must be considered in deciding which particular glass-ceramic material is suitable for use as the electronic device housing or enclosure. Furthermore, the material selected may also depend on aesthetics including color, surface finish, weight, density, among other properties, to be discussed hereinafter.

In one particular embodiment, the article suitable for use as an electronic device enclosure comprises a glass-ceramic material exhibiting both radio and microwave frequency transparency, as defined by a loss tangent of less than 0.5 and at a frequency range of between 15 MHz to 3.0 GHz, a fracture toughness of greater than 1.0 MPa·m^{1/2}, an equibiaxial flexural strength (hereinafter ring-on-ring or ROR strength) of greater than 100 MPa, a Knoop hardness of at least 400 kg/mm², a thermal conductivity of less than 4 W/m° C. and a porosity of less than 0.1%. This ROR strength is measured according the procedure set forth in ASTM: C1499-05.

Fracture toughness in a preferred embodiment can be as high as 1.2 MPa·m^{1/2}, when the glass-ceramic material utilized is for a transparent enclosure and as high as 5.0 MPa·m^{1/2} when the glass-ceramic material is opaque.

It is an important criterion for any glass-ceramic material which is intended for use as a portable electronic device enclosure that the material be capable of being easily fabricated into 3-dimensional shapes (i.e., non flat articles). It is known that 3-dimensional glass-ceramic parts can fabricated in one of three ways; the glass-ceramic material can be formed directly into the final shape (e.g., molding) or it can be initially formed into an intermediate shape and thereafter either machined or reformed into the final desired shape.

As previously mentioned, one approach to achieving efficiency in 3-dimensional shaping is to select a glass-ceramic material which exhibits good machinability. As such, it should be capable of being easily machined to high tolerances into the desired enclosure shape utilizing conventional/standard high speed metal-working tools, such as steel, carbide and/or diamond tools, without resulting in undue wear of the tools. Furthermore, a glass-ceramic which exhibits good machinability will exhibit minimal pits, chips and fracture damage following high speed machining utilizing the aforementioned tools. Glass-ceramics containing mica crystal phases is one example of a glass-ceramic material that exhibits excellent machinability.

Additionally, as previously mentioned it is desirable that the glass-ceramic material utilized be capable of easily being formed or reformed into the desired 3-dimensionally shaped enclosure. This forming or reforming process is typically accomplished through the utilization of standard processing techniques such as pressing, sagging, blowing, vacuum sagging, casting, sheet coin and powder sintering. Such forming and reforming minimizes the amount of subsequent finishing (e.g., polishing) required.

Regarding the reforming method of fabricating complex 3-dimensional shapes (e.g., housing or enclosure) this reforming step can involve initially fabricating the glass-ceramic material into an intermediate shape and thereafter re-heating the intermediate glass-ceramic article above the working temperature of its residual glass, such that the glass-ceramic part can be reshaped (sagged, stretched, etc.) with no change in the overall glass-ceramic microstructure and properties.

In another embodiment the article, particularly the electronic device enclosure exhibits radio and microwave frequency transparency, as defined by a loss tangent of less than 0.03 at a frequency range of between 15 MHz to 3.0 GHz. Still further embodiments include an enclosure having radio and microwave frequency transparency as defined by a loss tangent of less than 0.01 and less than 0.005 at a frequency range of between 15 MHz to 3.0 GHz. This radio and microwave frequency transparency feature is especially important for wireless hand held devices that include antennas internal to the enclosure. This radio and microwave transparency allows the wireless signals to pass through the enclosure and in some cases enhances these transmissions.

In a still further embodiment the electronic device housing or enclosure comprises a glass-ceramic which exhibits a fracture toughness of greater than 1.0 MPa·m^{1/2}, an ROR strength of greater than 150 MPa, preferably greater than 300 MPa.

Referring now particularly to the thermal conductivity attribute, it should be noted that thermal conductivities of the desired level, particularly of less than 4 W/m° C., are likely to result in a enclosure that remains cool to the touch even in high temperatures approaching as high as 100° C. Preferably, a thermal conductivity of less than 3 W/m° C., and less than 2 W/m° C. are desired. Representative thermal conductivities* (in W/m° C.) for some suitable silicate glass-ceramics (discussed in detail below) include the following:

| | |
|---|---|
| Cordierite glass-ceramic | 3.6 |
| beta spodumene (Corningware) | 2.2 |
| beta quartz (Zerodur) | 1.6 |
| wollastonite (Example 9 - below) | 1.4 |
| Machinable mica (Macor) | 1.3 |

*(see A. McHale, Engineering properties of glass-ceramics, in Engineered Materials Handbook, Vol. 4, Ceramics and Glasses, ASM International 1991.)

Other glass-ceramics which exhibit the requisite thermal conductivity feature included lithium disilicate based and canasite glass ceramics both of which are expected to exhibit thermal conductivity value of less than 4.0 W/m° C. For comparison, it should be noted that a ceramic such as alumina may exhibit undesirable thermal conductivities as high as 29.

It may also desirable that the enclosure be transparent, particularly a glass-ceramic material which is transparent in the visible spectrum from 400-700 nm with >50% transmission through 1 mm thickness.

In another aspect the glass-ceramic article, particularly enclosure can be subject to an ion exchange process. At least one surface of the glass-ceramic article is subject to an ion exchange process, such that the one ion exchanged (“IX”) surface exhibits a compressive layer having a depth of layer (DOL) greater than or equal to 2% of the overall article thickness and exhibiting a compressive strength of at least 300 MPa. Any ion exchange process known to those in the art is suitable so long as the above DOL and compressive strength are achieved. Such a process would include, but is not limited to submerging the glass ceramic article in a bath of molten Nitrate, Sulfate, and/or Chloride salts of Lithium, Sodium, Potassium and/or Cesium, or any mixture thereof. The bath and samples are held at a constant temperature above the melting temperature of the salt and below its decomposition temperature, typically between 350 and 800° C. The time required for ion-exchange of typical glass ceramics can range between 15 minutes and 48 hours, depending upon the diffusivity of ions through the crystalline and glassy phases. In certain cases, more than one ion-exchange process may be used to generate a specific stress profile or surface compressive stress for a given glass ceramic material.

In a more particular embodiment, the enclosure exhibits an overall thickness of 2 mm and compressive layer exhibiting a DOL of 40 μm with that compressive layer exhibiting a compressive stress of at least 500 MPa. Again any ion exchange process known by a person of skill in the art which achieves these features is suitable.

It should be noted that in addition to single step ion exchange processes, multiple ion exchange procedures can be utilized to create a designed ion exchanged profile for enhanced performance. That is, a stress profile created to a selected depth by using ion exchange baths of differing concentration of ions or by using multiple baths using different ion species having different ionic radii. Additionally, one or more heat treatments can be utilized before or after ion exchange to tailor the stress profile

As mentioned hereinabove, the preferred glass-ceramic materials for use as electronic device enclosures comprises silicate-based compositions due to their superior chemical durability and mechanical properties. A wide array of compositional families exist within the silicate materials family (see L. R. Pinckney, “Glass-Ceramics”, Kirk-Othmer Encyclopedia of Chemical Technology, 4th edition, Vol. 12, John Wiley and Sons, 627-644, 1994).

Particular glass-ceramics suitable for use herein include, without limitation, glass-ceramics based on:
(1) Simple silicate crystals, such as lithium disilicate (Li₂Si₂O₅), enstatite (MgSiO₃), and wollastonite (CaSiO₃);
(2) Aluminosilicate crystals, such as those from the Li₂O—Al₂O₃—SiO₂, MgO—Al₂O₃—SiO₂, and Al₂O₃—SiO₂ systems, with crystal phases including stuffed β-quartz, β-spodumene, cordierite, and mullite;
(3) Fluorosilicate crystals, such as alkali and alkaline earth micas as well as chain silicates such as potassium richterite and canasite; and
(4) Oxide crystals within silicate host glasses, such as glass-ceramics based on spinel solid solution (e.g. (Zn,Mg)Al₂O₄) and quartz (SiO₂).

Representative examples of glass-ceramic materials suitable for housings are given in Table I. Most of these glass-ceramics can be internally-nucleated, wherein the primary crystal phase(s) nucleate upon an initial crystal phase or within phase-separated areas. For some glass-ceramic materials, for example those based upon wollastonite, it may be preferable to employ standard powder processing (frit sintering) methods. Coloring agents, such as transition metal oxides, can be added to all of these materials, and all can be glazed if desired.

In the broadest embodiment the representative examples of Table I, include compositions according to the invention which consist essentially of, in weight percent as oxides on a batched basis, 40-80% SiO₂, 0-28% Al₂O₃, 0-8% B₂O₃, 0-18% Li₂O, 0-10% Na₂O, 0-11% K₂O, 0-16% MgO, 0-18% CaO, 0-10% F, 0-20% SrO, 0-12% BaO, 0-8% ZnO, 0-8% P₂O₅, 0-8% TiO₂, 0-5% ZrO₂, and 0-1% SnO₂.

Additionally, disclosed in Table 1 are certain representative properties which have been achieved/measured for each of the representative compositions; Strain Point (Strain), Annealing Point (Anneal) Density (Density), Liquidus Temperature (Liq. Temp) ring-on-ring equibiaxial flexure strength (ROR Strength), ion-exchanged ring-on-ring equibiaxial flexure strength (IX ROR Strength), Fracture Toughness (Fract. Tough), Elastic Modulus (Modulus), Shear Modulus (S Modulus) and Poisson's Ratio (P Ratio) Knoop Hardness (Knoop H).

TABLE I

| | 1 | 2 | 3 | 4 | 5 | 6 | 7 | 8 | 9 | 10 | 11 |
|---|---|---|---|---|---|---|---|---|---|---|---|
| SiO₂ | 65.3 | 74.4 | 75.0 | 47.2 | 67 | 45 | 42 | 60 | 57 | 50 | 67.52 |
| Al₂O₃ | 20.1 | 3.6 | | 17 | | 12 | 14 | 8 | 2 | 25 | 20.38 |
| B₂O₃ | 2.0 | | | 7 | | | | 1 | | 1 | |
| Li₂O | 3.6 | 15.4 | 17.2 | | | | | | | | 3.48 |
| Na₂O | 0.3 | | | 7.8 | | | | 4 | 8 | | 0.1 |
| K₂O | | 3.3 | 2.2 | | 10 | 2.5 | | 1 | 9 | | |
| MgO | 1.8 | | 0.7 | 8.3 | 14 | 11 | 10 | | | 14 | 1.25 |
| MgF₂ | | | | 12.7 | 9 | 12 | 12 | | | | 1.25 |
| CaO | | | | | | | | 16 | 10.7 | | |
| CaF₂ | | | | | | | | | 13.7 | | |
| SrO | | | | | | 17.5 | 12 | | | | |
| BaO | | | | | | | 10 | 4 | | | |
| ZnO | 2.2 | | 1.9 | | | | | 6 | | | 1.2 |
| P₂O₅ | | 3.4 | 2.9 | | | | | | | | |
| TiO₂ | 4.4 | | | | | | | | | 7 | 4.77 |
| ZrO₂ | | | | | | | | | | 3 | |
| SnO₂ | 0.3 | | | | | | | | | | |
| Crystal | (1) | (2) | (3) | (5) | (6) | (7) | (8) | (9) | (10) | (11) | (12) |
| Strain (° C.) | 792 | 789 | | | | | | | | 960 | |
| Anneal (° C.) | 876 | 821 | | | | | | | | 996 | |
| Density | 2.53 | 2.41 | 2.55 | 3.05 | | | | | 2.62 | 3.1 | |
| (g/cm³) | | | | | | | | | | | |
| Liq. Temp | 1210 | 1020 | 960 | | | | | | | 1300 | |
| RoR | 350 | 400 | 300 | 100 | | | | | | | 167 |
| Strength* | | | | | | | | | | | |
| (MPa) | | | | | | | | | | | |
| IX RoR | 700 | 750 | | | | | | | | | 645 |
| Strength* | | | | | | | | | | | |
| (MPa) | | | | | | | | | | | |
| Fract Tough | 1 | 2.1 | 3.2 | 1.3 | | 1.91 | | | 4-5 | 1.3 | |
| (MPa m^{1/2} ) | | | | | | | | | | | |
| Modulus | 86 | 103 | 110 | 59 | | 66 | | | 82 | | |
| (GPa) | | | | | | | | | | | |
| Shear Mod | 34 | 43 | 45 | 23 | | 25 | | | | | |
| (GPa) | | | | | | | | | | | |
| P Ratio | 0.245 | 0.205 | 0.22 | 0.268 | | 0.297 | | | | | |
| Knoop H | | | | | | | | | 530 | 1200 | |

*ASTM: C1499-05

The primary crystal phases (Crystal) for each of the glass-ceramic compositions listed above in Table I is as follows:
(1) β-spodumene or β-quartz solid solution;
(2) Lithium disilicate;
(3) Lithium disilicate;
(4) Trisilicic mica GC;
(5) Trisilicic mica GC;
(6) Tetrasilicic mica GC;
(7) Alkaline earth mica GC;
(8) Alkaline earth mica GC;
(9) Wollastonite;
(10) Canasite;
(11) Spinel, sapphirine, α-quartz.
(12) β-spodumene solid solution

It should be noted that the example 1 β-partz solid solution, detailed above in Table I, can be made transparent if heat-treated so as to achieve that transparency feature. It is readily apparent to one skilled in the art which specific heat treatments can achieve this transparency.

Generally, the process for forming any of the representative glass-ceramic materials detailed above in Table I comprises melting a batch for a glass consisting essentially, in weight percent on the oxide basis as calculated from the batch, of a composition within the range set forth above. It is within the level of skill for those skilled in the glass-ceramic art to select the required raw materials necessary as to achieve the desired composition. Once the batch materials are sufficiently mixed and melted, the process involves cooling the melt at least below the transformation range thereof and shaping a glass article therefrom, and thereafter heat treating this glass article at temperatures between about 650-1,200° C. for a sufficient length of time to obtain the desired crystallization in situ. The transformation range has been defined as that range of temperatures over which a liquid melt is deemed to have been transformed into an amorphous solid, commonly being considered as being between the strain point and the annealing point of the glass.

The glass batch selected for treatment may comprise essentially any constituents, whether oxides or other compounds, which upon melting to form a glass will produce a composition within the aforementioned range. Fluorine may be incorporated into the batch using any of the well-known fluoride compounds employed for the purpose in the prior art which are compatible with the compositions herein describe

Heat treatments which are suitable for transforming the glasses of the invention into predominantly crystalline glass-ceramics generally comprise the initial step of heating the glass article to a temperature within the nucleating range of about 600-850° C. and maintaining it in that range for a time sufficient to form numerous crystal nuclei throughout the glass. This usually requires between about ¼ and 10 hours. Subsequently, the article is heated to a temperature in the crystallization range of from about 800-1,200° C. and maintained in that range for a time sufficient to obtain the desired degree of crystallization, this time usually ranging from about 1 to 100 hours. Inasmuch as nucleation and crystallization in situ are processes which are both time and temperature dependent, it will readily be understood that at temperatures approaching the hotter extreme of the crystallization and nucleation ranges, brief dwell periods only will be necessitated, whereas at temperatures in the cooler extremes of these ranges, long dwell periods will be required to obtain maximum nucleation and/or crystallization.

It will be appreciated that numerous modifications in the crystallization process are possible. For example, when the original batch melt is quenched below the transformation range thereof and shaped into a glass article, this article may subsequently be cooled to room temperature to permit visual inspection of the glass prior to initiating heat treatment. It may also be annealed at temperatures between about 550-650° C. if desired. However, where speed in production and fuel economies are sought, the batch melt can simply be cooled to a glass article at some temperature just below the transformation range and the crystallization treatment begun immediately thereafter.

Glass-ceramics may also be prepared by crystallizing glass frits in what is referred to as powder processing methods. A glass is reduced to a powder state, typically mixed with a binder, formed to a desired shape, and fired and crystallized to a glass-ceramic state. In this process, the relict surfaces of the glass grains serve as nucleating sites for the crystal phases. The glass composition, particle size, and processing conditions are chosen such that the glass undergoes viscous sintering to maximum density just before the crystallization process is completed. Shape forming methods may include but are not limited to extrusion, pressing, and slip casting.

Additional glass-ceramics were produced based on certain of the representative compositions disclosed above in Table I and they are described in additional detail below.

A first exemplary glass-ceramic is based on crystals with a β-spodumene structure (Example 1 in Table 1). As noted by Duke et al. (Chemical strengthening of glass-ceramics, Proc. XXXVI International Congress in Industrial Chemistry, Brussels, Belgium, 1-5, 1966, the β-spodumene composition is basically LiAlSi₂O₆, with solid solutions toward SiO₂, MgAl₂O₄, and ZnAl₂O₄. Its crystal structure contains continuous channels which may provide paths for Li⁺ ion movement at elevated temperatures, thereby making these crystals very amenable to chemically strengthening (i.e., ion exchange). Duke et al. demonstrated Na⁺ for Li⁺ ion exchange of a simple Li₂O—Al₂O₃—SiO₂—TiO₂ composition, in a mixed salt bath of 85% NaNO₃-15% Na₂SO₄ at 580 C. This strengthened material provided equibiaxial flexure strength (ROR strength) of 63 kg/mm² (90,000 psi, 620 MPa). It should be noted that ion exchange experiments utilizing the Example 1 composition have yielded ROR strengths of over 100,000 psi (690 MPa). The microwave frequency dielectric properties for this first exemplary were also very good, with a dielectric constant of 7 and loss tangent ranging between about 0.003-0.005 and at a frequency range of between 15 MHz to 3.0 GHz.

A second exemplary glass-ceramic was formed comprising the composition of Example 7 in Table 1. This mica-based glass-ceramic was readily machinable with standard carbide or diamond tooling. While this non-alkali material was not easily ion-exchangeable, it provided ROR strengths ranging between about 20-25,000 psi (140-170 MPa), a fracture toughness ranging between about 1.7-1.8 MPa·m^{1/2}, and excellent dielectric properties (dielectric constant=6.95, loss tangent=0.002 over the frequency range of between 15 MHz to 3.0 GHz.)

A third example, a lithium disilicate glass ceramic, was prepared from a glass comprised of the composition of Example 2 in Table 1. The raw materials consisted of silicon dioxide, aluminum oxide, lithium carbonate, potassium nitrate, and aluminum phosphate. These were mixed by ball milling for 60 minutes before melting in a platinum crucible at 1450° C. overnight. The melt was poured into molds and transferred to an annealing oven at 450° C. and cooled slowly to room temperature. The glass patties were then heat treated to form the glass ceramic article. The heat treatment consisted of a ramp from room temperature to 700° C. at 150K/hr, followed by a 2 hour hold for nucleation of the crystallites. The sample was then heated to 850° C. at 150K/hr and held for 2 hours to grow the nuclei. The glass ceramic cooled at the natural furnace cooling rate to room temperature. Samples were cut from these cerammed patties for ring-on-ring equibiaxial flexure strength measurements. The heat treatment was repeated on these samples to heal any surface flaws generated during machining. The samples were then ion-exchanged in a molten salt bath of pure potassium nitrate at 410° C. for 24 hours. This process produced an average strength of 757 MPa as measured by ring-on-ring equibiaxial flexure (ROR Strength).

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

We claim:

1. An article suitable for housing or enclosing the components of a portable electronic device, the article comprising a glass-ceramic material exhibiting both radio and microwave frequency transparency, as defined by a loss tangent of less than 0.5 and at a frequency range of between 15 MHz to 3.0 GHz, a fracture toughness of greater than 1.0 MPa·m^{1/2}, an ROR strength of greater than 100 MPa, a Knoop hardness of at least 400 kg/mm², a thermal conductivity of less than 4 W/m° C. and a porosity of less than 0.1%.

2. The article claimed in claim 1 wherein the glass-ceramic exhibits good machinability when machined with steel, carbide and/or diamond tools.

3. The article claimed in claim 1 wherein the glass-ceramic exhibits radio and microwave frequency transparency, as defined by a loss tangent of less than 0.03 at a frequency range of between 15 MHz to 3.0 GHz.

4. The article claimed in claim 1 wherein the glass-ceramic exhibits radio and microwave frequency transparency, as defined by a loss tangent of less than 0.01 at a frequency range of between 15 MHz to 3.0 GHz.

5. The article claimed in claim 1 wherein the glass-ceramic exhibits a fracture toughness of greater than 1.2 MPa·m^{1/2} for transparent glass-ceramic and up to 5.0 MPa·m^{1/2} for opaque glass ceramics.

6. The article claimed in claim 1 wherein the glass-ceramic exhibits an ROR strength of greater than 150 MPa.

7. The article claimed in claim 1 wherein the glass-ceramic exhibits an ROR strength of greater than 300 MPa.

8. The article claimed in claim 1 wherein the glass-ceramic exhibits a thermal conductivity of less than 3 W/m° C.

9. The article claimed in claim 1 wherein the glass-ceramic exhibits a thermal conductivity of less than 2 W/m° C.

10. The article claimed in claim 1 wherein the glass-ceramic is transparent in the visible spectrum from 400-700 nm with >50% transmission through 1 mm thickness.

11. The article claimed in claim 1 wherein the glass-ceramic is a silicate based glass-ceramic and the predominate crystal phase is selected from the group consisting of lithium disilicate, enstatite and wollastonite.

12. The article claimed in claim 1 wherein the glass-ceramic is an aluminosilicate, based glass-ceramic and the predominate crystal phase is selected from the group consisting of stuffed β-quartz, β-spodumene, cordierite, and mullite.

13. The article claimed in claim 1 wherein the glass-ceramic is a fluorosilicate based glass-ceramic and the predominate crystal phase is selected from the group consisting of potassium richterite and canasite.

14. The article claimed in claim 1 wherein the glass-ceramic is comprised of oxide crystals within silicate host precursor glasses and the predominate crystal phase is selected from the group consisting of spinel solid solution and quartz.

15. The article as claimed in claim 1 wherein at least one surface of the glass-ceramic article is subject to an ion exchange process and wherein the one ion exchanged surface exhibits a compressive layer having a depth of layer (DOL) greater than or equal to 2% of the overall article thickness and exhibiting a compressive strength of at least 300 MPa.

16. The article as claimed in claim 15 wherein the article exhibits an overall thickness of 2 mm and compressive layer exhibiting a DOL of 40 μm.

17. The article as claimed in claim 15 wherein the article compressive layer exhibits a compressive stress of at 500 MPa.

18. The article as claimed in claim 1 wherein the article is formable by standard processing techniques selected from the group consisting of pressing, sagging, vacuum sagging, casting, sheet coin, and powder sintering.

19. The article as claimed in claim 1 wherein the glass-ceramic exhibits a liquidus viscosity of greater than 50 poise at temperatures below 1275° C.

20. The article as claimed in claim 1, wherein the glass-ceramic consists essentially of, in weight percent as oxides on a batched basis, 40-80% SiO₂, 0-28% Al₂O₃, 0-8% B₂O₃, 0-18% Li₂O, 0-10% Na₂O, 0-11% K₂O, 0-16% MgO, 0-18% CaO, 0-10% F₂, 0-20% SrO, 0-12% BaO, 0-8% ZnO, 0-8% P₂O₅, 0-8% TiO₂, 0-5% ZrO₂, and 0-1% SnO₂.
